(19) United States
(12) Patent Application Publication
(10) Pub. No.: US 2026/0128965 A1
(43) Pub. Date: May 7, 2026

(54) SYSTEMS AND METHODS FOR ESTIMATING WIRELESS NETWORK OUTAGE IMPACT OF A NETWORK ASSET

(71) Applicant: Verizon Patent and Licensing Inc., Basking Ridge, NJ (US)

(72) Inventors: Ammara ESSA, Los Angeles, CA (US); Hector Alejandro GARCIA CRESPO, N Richland Hills, TX (US); Matthew KAPALA, North Billerica, MA (US); John N. WAKIM, Salem, NH (US); Chad HOOPER, Plainfield, IL (US); Timothy E. COYLE, Chicopee, MA (US)

(73) Assignee: Verizon Patent and Licensing Inc., Basking Ridge, NJ (US)

(21) Appl. No.: 18/936,143

(22) Filed: Nov. 4, 2024

(51) Int. Cl. H04L 41/5009; H04L 41/0677; H04L 43/0817

(52) U.S. Cl. CPC H04L 41/5009; H04L 41/0677; H04L 43/0817

(57) ABSTRACT

A device may identify assets associated with potential network outages, may receive best serving plot information for an asset of the assets, and may receive asset plots for geographic areas associated with remaining assets. The device may identify a coverage band for the asset based on the best serving plot information, may determine coverage tiers for the geographic areas based on the asset plots, and may calculate next best serving assets for the geographic areas. The device may compute PDFs for the coverage band and the coverage tiers associated with next best serving assets, may compute an intersection of the PDFs, and may calculate an area under the intersection to generate a coverage overlap coefficient. The device may utilize the coverage overlap coefficient to scale KPIs of the asset and to generate updated KPIs of the asset, and may perform one or more actions based on the updated KPIs.

### BACKGROUND

Wireless networks are an indispensable part of modern communication infrastructures, providing connectivity to numerous devices and services. With the dynamic evolution of network technologies and the expansion of coverage areas, the integrity of wireless networks is paramount to consistent user experience.

### BRIEF DESCRIPTION OF THE DRAWINGS

FIGS. 1A-1J are diagrams of an example associated with estimating wireless network outage impact of a network asset.

FIG. 2 is a diagram of an example environment in which systems and/or methods described herein may be implemented.

FIG. 3 is a diagram of example components of one or more devices of FIG. 2.

FIG. 4 is a flowchart of an example process for estimating wireless network outage impact of a network asset.

### DETAILED DESCRIPTION OF EXAMPLE EMBODIMENTS

The following detailed description of example implementations refers to the accompanying drawings. The same reference numbers in different drawings may identify the same or similar elements.

Existing wireless infrastructure often faces challenges due to aging assets, such as battery backup systems for aspects of network elements, which are essential for maintaining network service during power outages. As equipment reaches the end of a service life, network operators must prioritize replacement of the equipment to ensure continuous operation. However, logistical constraints make it impractical to replace all aging equipment simultaneously. Thus, network operators must determine which assets (e.g., network sites) are most critical and should be prioritized for asset replacement. Decisions based on location categories (e.g., urban versus rural), a population covered, or network performance metrics may not fully capture a criticality of a particular site within a broader network context. Moreover, there exists an additional layer of complexity in analyzing a potential service impact when multiple sites experience simultaneous outages, which can leave a disproportionate effect on the network. Thus, current techniques for handling replacement or maintenance of network assets consume computing resources (e.g., processing resources, memory resources, communication resources, and/or the like), networking resources, and/or other resources associated with failing to provide a reliable, data-driven approach to quantifying impacts of network asset outages, generating suboptimal asset management and response strategies based on failing to accurately quantify impacts of network asset outages, especially in important scenarios, such as during natural disasters or high-demand events, and/or the like.

Some implementations described herein provide a device (e.g., a management system) that estimates wireless network outage impact of a network asset. For example, the management system may identify assets associated with potential network outages, may receive best serving plot information for an asset of the assets and at a geospatial level, and may receive asset plots for aggregate distinct geographic areas associated with remaining assets of the assets. The management system may identify a coverage band for the asset based on the best serving plot information, may determine coverage tiers for the geographic areas based on the asset plots, and may calculate next best serving assets for the geographic areas based on the coverage band and the coverage tiers. The management system may compute probability density functions (PDFs) for the coverage band and the coverage tiers associated with next best serving assets, may compute an intersection of the PDFs, and may calculate an area under the intersection to generate a coverage overlap coefficient for the asset. The management system may utilize the coverage overlap coefficient to scale key performance indicators (KPIs) of the asset and to generate updated KPIs of the asset, and may perform one or more actions based on the updated KPIs.

In this way, the management system estimates wireless network outage impact of a network asset. For example, the management system may identify wireless network sites as assets, and may obtain geospatial coverage data for the network sites. The management system may identify a coverage band for each network site, and may determine coverage tiers for the network sites. The management system may calculate next best service alternatives, and may compute PDFs for overlapping coverage areas. The management system may calculate an area under the PDFs to generate a coverage overlap coefficient, and may utilize the coverage overlap coefficient to adjust KPIs related to the network sites, which in turn informs maintenance schedules, replacement recommendations, or other optimization actions for the network sites. Thus, the management system may conserve computing resources, networking resources, and/or other resources that would have otherwise been consumed by failing to provide a reliable, data-driven approach to quantifying impacts of network asset outages, generating suboptimal asset management and response strategies based on failing to accurately quantify impacts of network asset outages, especially in important scenarios, such as during natural disasters or high-demand events, and/or the like.

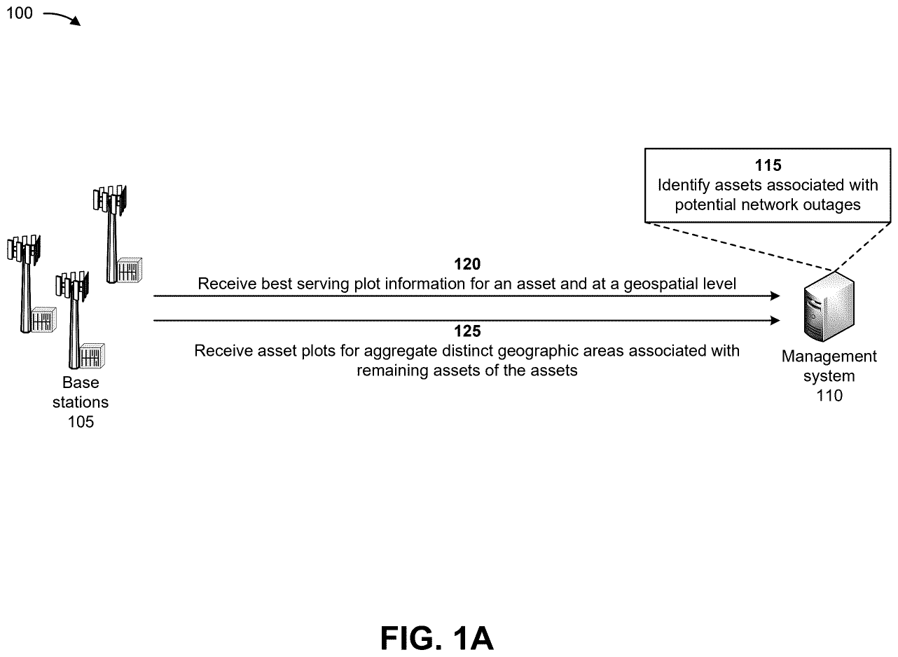

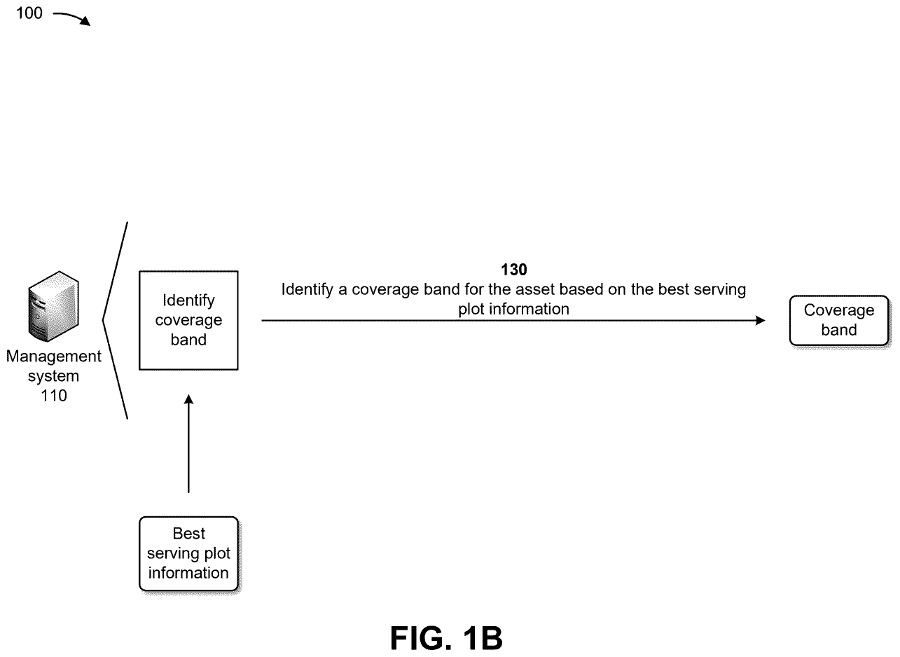

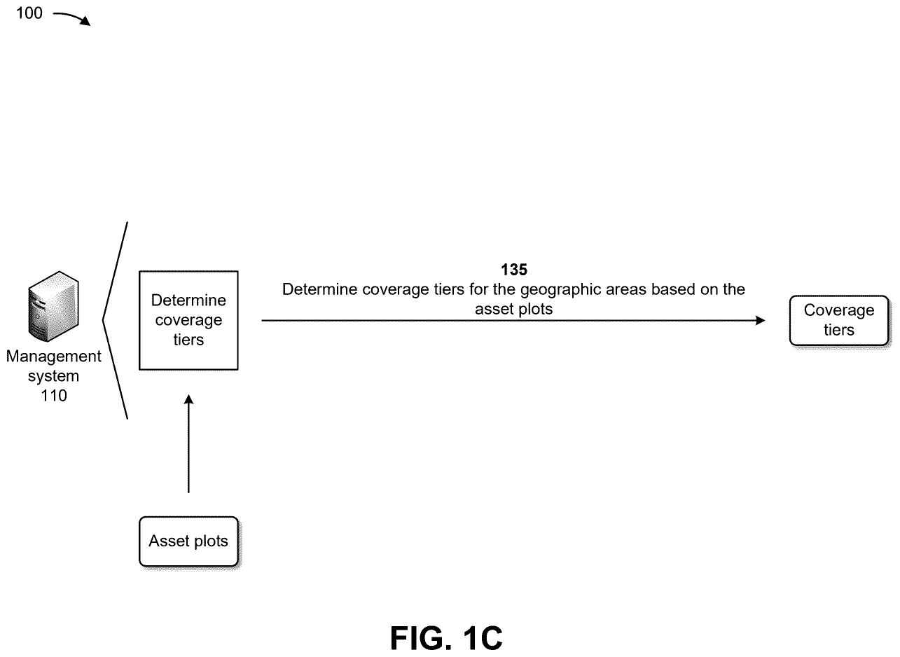

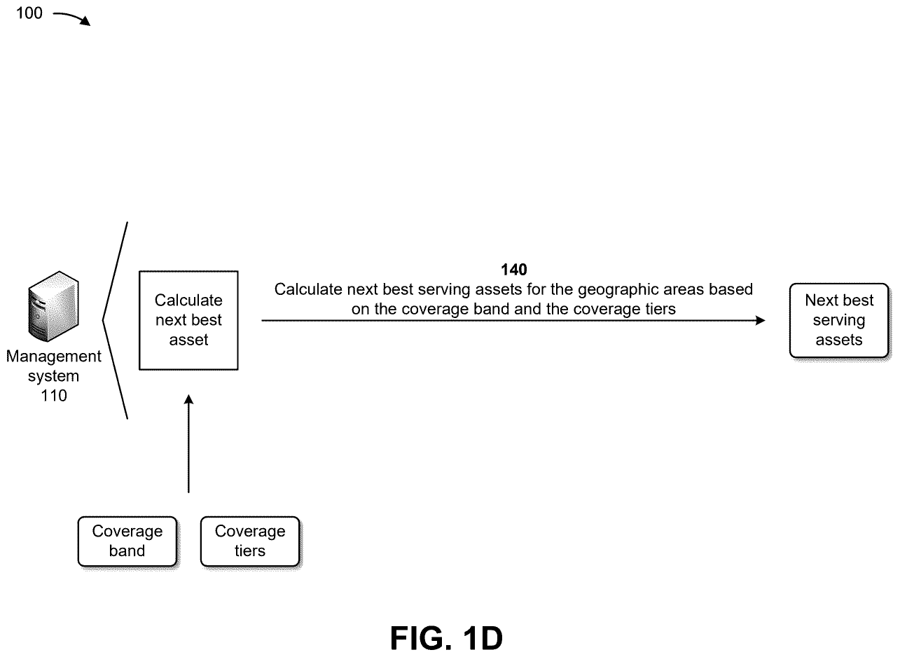

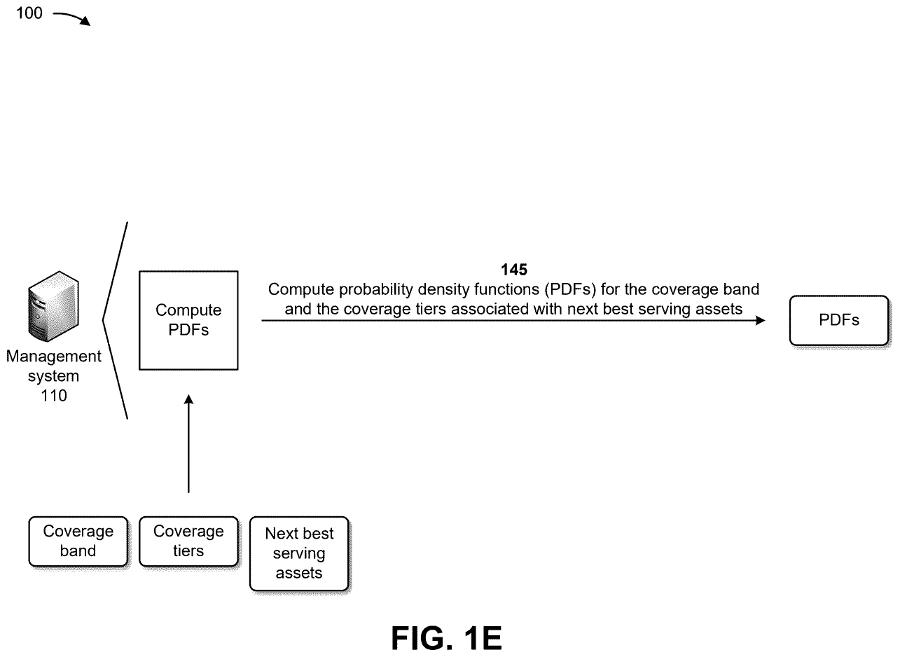

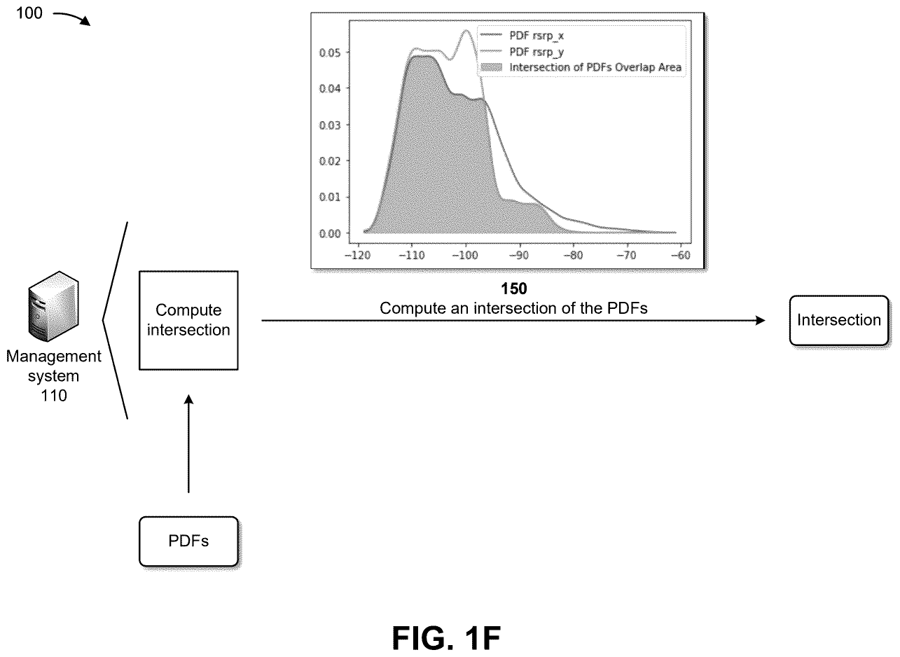

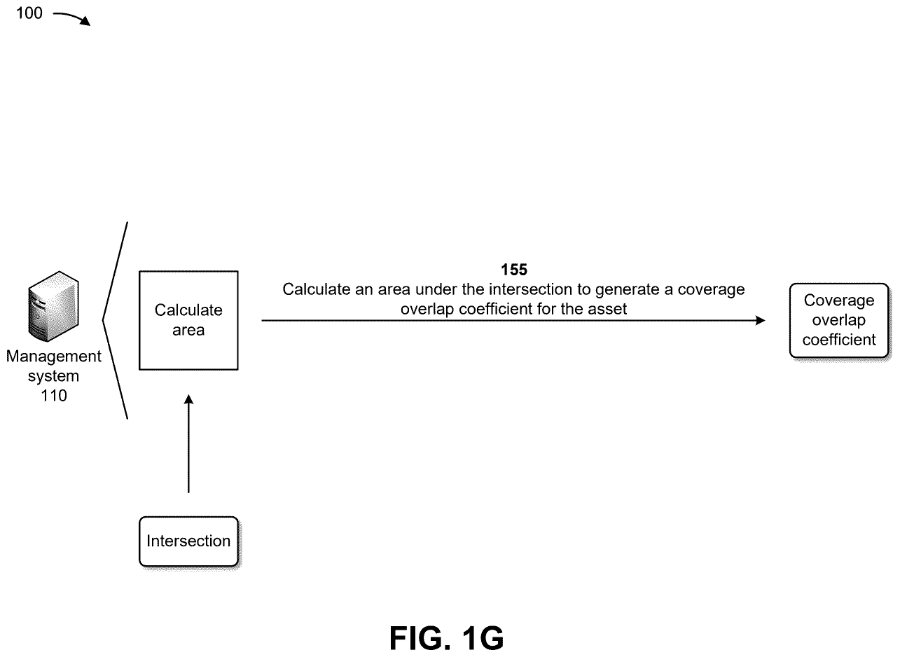

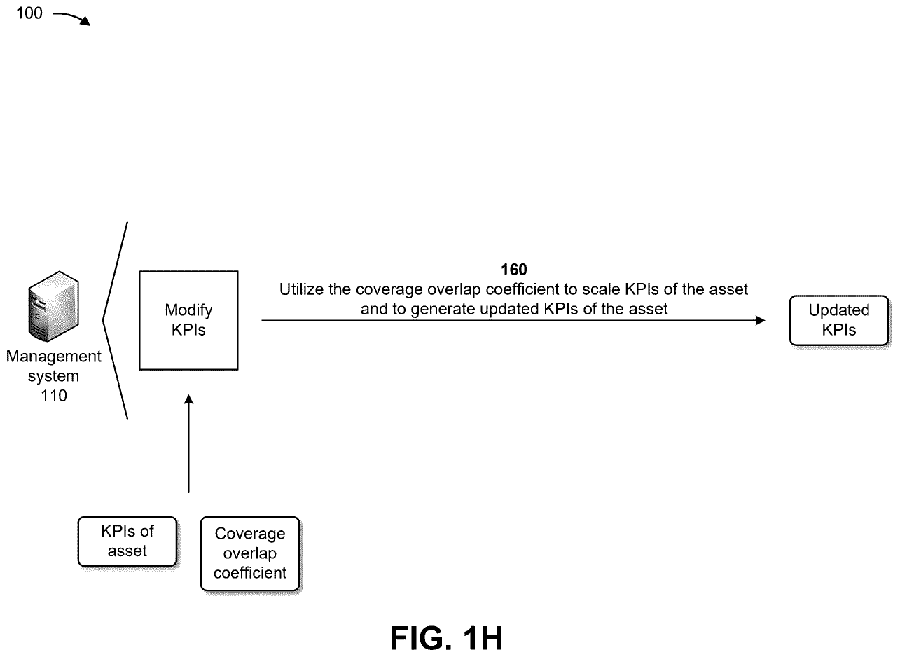

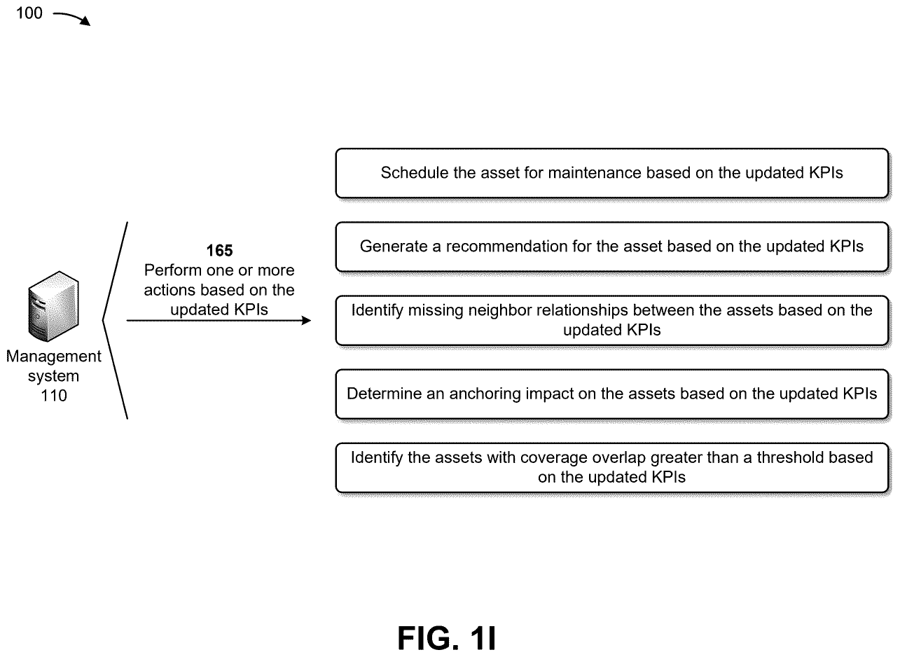

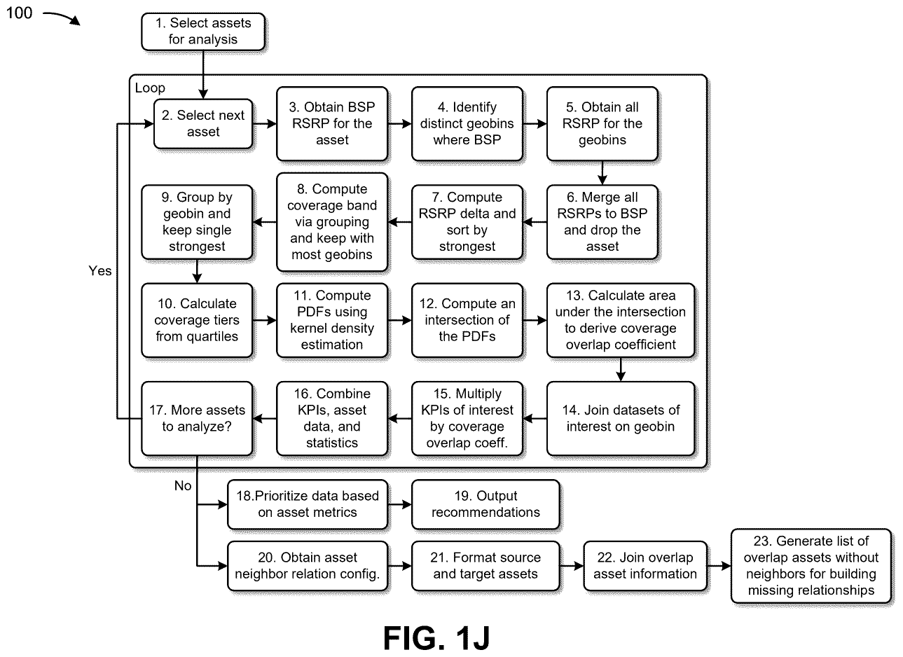

FIGS. 1A-1J are diagrams of an example 100 associated with estimating wireless network outage impact of a network asset. As shown in FIGS. 1A-1J, the example 100 includes base stations 105 (e.g., of a wireless network) associated with a management system 110. Further details of the base stations 105 and the management system 110 are provided elsewhere herein. In some implementations, one or more of the functions described herein as being performed by the management system 110 may be performed by the base stations 105. Furthermore, the terms “asset” or “network asset,” as used herein, may refer to a base station 105, a network device, a server device, and/or the like of a wireless network.

As shown in FIG. 1A, and by reference number 115, the management system 110 may identify assets associated with potential network outages. For example, the management system 110 may scan and evaluate network infrastructure to pinpoint assets prone to failure or service disruptions, especially during events such as natural disasters or high-demand scenarios. The assets may include the base stations 105, batteries utilized in the base stations 105, components of the base stations 105 that are prone to failure or service disruptions, and/or the like.

In some implementations, the management system 110 may continuously monitor the health and performance of these assets using predefined metrics and thresholds. For example, assets may be flagged based on age, performance degradation, or other risk indicators. In some implementations, the management system 110 may periodically evaluate a condition of an asset based on historical failure data and predictive analytics. This may include the management system 110 analyzing past performance and failure data to identify assets more likely to encounter issues. Additionally, or alternatively, the management system 110 may utilize machine learning models to predict potential outage risks by analyzing patterns and anomalies in the asset performance data. For example, the management system 110 may detect an unusual drop in signal strength or increased error rates, indicating a potential future failure.

Additionally, or alternatively, the management system 110 may identify assets at risk of failure due to aging infrastructure or severe weather conditions based on meteorological and environmental data integration. For example, the management system 110 may use weather forecasts and aging data to anticipate issues, ensuring maintenance crews are preemptively deployed to high-risk areas. Additionally, or alternatively, the management system 110 may utilize an artificial intelligence (AI)-driven monitoring system to continuously assess and prioritize assets for preventative maintenance based on real-time health indicators. The management system 110 may use AI to monitor signals from various sensors, ensuring timely interventions before critical failures occur. Additionally, or alternatively, the management system 110 may use a combination of sensor data and remote diagnostics to forecast potential asset failures. By integrating data from temperature, humidity, and other environmental sensors, the management system 110 may provide a comprehensive assessment of asset health.

As further shown in FIG. 1A, and by reference number 120, the management system 110 may receive best serving plot information for an asset and at a geospatial level. For example, the management system 110 may collect information identifying the zones or geographical areas where each network asset provides the strongest and most reliable service. In some implementations, this information may be received via a best serving plot. This data regarding strongest and most reliable service of a network asset may be derived from radio frequency (RF) propagation models or real-time network performance measurements. In some implementations, the management system 110 may periodically generate updated best serving plots to reflect network changes or environmental variations. In some implementations, the management system 110 may utilize crowd-sourced user data to dynamically refine and update best serving plot information. For example, the management system 110 may utilize data from devices connected to the base stations (e.g., user equipment (UE)) to provide a real-time picture of network coverage and performance.

Additionally, or alternatively, the management system 110 may gather best serving plot information from a combination of drive tests and in-situ RF measurements to enhance accuracy. This may include conducting field tests using vehicles equipped with measurement tools to gather detailed coverage data. Additionally, or alternatively, the management system 110 may integrate best serving plot data with geographic information system (GIS) layers for a more precise delineation of service areas. By combining RF data with GIS maps, the management system 110 may provide a visualization of coverage in conjunction with physical and socio-economic features of an area. Additionally, or alternatively, the management system 110 may update the best serving plot information in real-time based on network performance metrics such as signal strength indicators (e.g., reference signal received power (RSRP) and signal-to-interference-plus-noise ratio (SINR)). Additionally, or alternatively, the management system 110 may employ advanced RF simulation tools to model and predict the best serving plots under different network load scenarios. These simulations may help anticipate how network changes, such as peak loads or new constructions, might affect coverage.

As further shown in FIG. 1A, and by reference number 125, the management system 110 may receive asset plots for aggregate distinct geographic areas associated with remaining assets of the assets (e.g., all of the assets except the asset associated with the best serving plot information). For example, the management system 110 may gather a comprehensive grid of asset plots encompassing all geographic areas served by the remaining network assets. These plots offer a detailed mapping of coverage, helping to identify overlapping coverage regions and potential weak spots. In some implementations, the data from these plots may be integrated with additional datasets to include parameters such as population density, traffic load, and environmental factors, providing a richer context for decision-making. In some implementations, the management system 110 may collect comprehensive asset plots by merging coverage data from multiple frequency bands to provide a holistic view of network service areas. The management system 110 may aggregate data from different frequencies to ensure coverage insight across all bands used by the network.

Additionally, or alternatively, the management system 110 may integrate asset plot data with socio-demographic information to correlate service coverage with user density and profiles. By combining coverage maps with demographic data, the management system 110 may tailor services to the needs of various user groups. Additionally, or alternatively, the management system 110 may analyze the asset plots concerning competitive network footprints to identify strategic coverage gaps or overlaps. This analysis may aid in understanding the competitive landscape and in planning network expansions or enhancements. Additionally, or alternatively, the management system 110 may utilize spatial-temporal analysis to track changes in network coverage and performance over time, aiding in dynamic adjustment of asset plots. The management system 110 may analyze historical data to detect trends and changes in coverage. Additionally, or alternatively, the management system 110 may aggregate asset plots with additional infrastructure maps, such as transport and utility grids, to facilitate coordinated maintenance and upgrades. Integrating the network coverage data with other infrastructure maps may ensure that maintenance schedules are optimized and cost-effective.

As shown in FIG. 1B, and by reference number 130, the management system 110 may identify a coverage band for the asset based on the best serving plot information. For example, the management system 110 may analyze the best serving plot information, which represents the zones or geographical areas where each network asset provides the optimal service coverage, to identify the coverage band for the asset. Analyzing the best serving plot information may enable the management system 110 to determine specific frequency bands used by the asset to serve these geographical areas, such as low-band, mid-band, or high-band frequencies, ensuring precise mapping and accurate service predictions. Identifying the coverage band for the asset may enable the management system 110 to identify different bands that cover varying distances and types of terrain. In some implementations, the management system 110 may identify the coverage band for the asset by evaluating signal strength and quality metrics, such as RSRP and reference signal received quality (RSRQ). For example, the coverage band may be characterized by propagation attributes, interference levels, and service reliability captured in the best serving plot information.

Additionally, or alternatively, the management system 110 may identify the coverage band for the asset by analyzing the best serving plot information to determine an optimal frequency band for the asset. For example, the optimal frequency band determination may consider factors such as signal-to-noise ratio (SNR) and coverage area consistency to ensure the best performance. Additionally, or alternatively, the management system 110 may identify the coverage band for the asset by identifying which frequency band offers the best service based on historical data and current network conditions. Additionally, or alternatively, the management system 110 may identify the coverage band for the asset by classifying the coverage band based on interpreting the best serving plot information. For example, the classification can include segmenting service regions into different band classifications for targeted optimization.

Additionally, or alternatively, the management system 110 may identify the coverage band for the asset by distinguishing the appropriate coverage band for the asset through the best serving plot details. An example would be distinguishing between urban and rural coverage needs and selecting the appropriate frequency for each. Additionally, or alternatively, the management system 110 may identify the coverage band for the asset by ascertaining the coverage band for the asset based on best serving plot metrics. For example, the management system 110 may utilize metrics, such as UE connectivity rates and handover success rates, to ascertain the most effective band. Identification of the coverage band for the asset may enable further network optimization steps, and may ensure that resources are focused on maintaining the most critical coverage bands.

As shown in FIG. 1C, and by reference number 135, the management system 110 may determine coverage tiers for the geographic areas based on the asset plots. For example, the management system 110 may utilize the asset plots, which provide a detailed mapping of the coverage areas served by the network assets, to categorize the geographic areas into distinct coverage tiers based on signal strength, quality, and other relevant metrics. The coverage tiers may include classifications, such as near-cell, mid-cell, and far-cell, reflecting varying levels of service quality and signal strength across the geographic areas. In some implementations, the management system 110 may use statistical methods and models to accurately segment the geographic areas into the coverage tiers. For example, the management system 110 may analyze the distribution of signal strength values (e.g., RSRP) within the asset plots and may apply quartile-based segmentation to define the boundaries of each coverage tier.

Additionally, or alternatively, the management system 110 may consider factors such as user density, environmental conditions, and historical performance data to refine the coverage tier determinations. For example, areas with high user density and significant signal quality variations may receive higher priority in coverage tier classifications to ensure optimal network performance. Determining coverage tiers for the geographic areas based on the asset plots may enable the management system 110 to create an accurate representation of the network's service distribution, which may be utilized for various optimization tasks, including maintenance scheduling, asset replacement prioritization, and network performance enhancement. The coverage tiers may inform subsequent calculations, such as identifying the next best serving assets or computing PDFs for coverage metrics. Additionally, or alternatively, the management system 110 may analyze service quality metrics, such as signal-to-noise ratios or data throughput rates, to determine the appropriate tier for each geographic area.

In some implementations, determining the coverage tiers for geographic areas may include the management system 110 analyzing the asset plots and categorizing regions into different service quality levels based on insights from the asset plots. For example, the asset plots may provide detailed visualizations of where signal degradation occurs, helping to precisely define the coverage tiers. Additionally, or alternatively, regions with high network congestion identified in the asset plots may be given higher priority and classified accordingly to enhance service quality. In some implementations, the management system 110 may categorize the geographic areas into the coverage tiers using detailed information, such as signal strength and user density. For example, signal strength data aggregated and statistically analyzed from the asset plots may provide bases for the coverage tier definitions. Additionally, or alternatively, high user density areas, identified from historical usage patterns, may require more granular categorization to balance load and improve network performance.

As shown in FIG. 1D, and by reference number 140, the management system 110 may calculate next best serving assets for the geographic areas based on the coverage band and the coverage tiers. For example, the management system 110 may evaluate alternative network assets capable of covering the same geographic areas based on the identified coverage band and the coverage tiers. For example, the management system 110 may utilize historical performance data and real-time monitoring to identify assets that can provide equivalent or better service continuity. The historical performance data may include metrics, such as prior service disruptions and performance records during peak usage periods. Additionally, or alternatively, calculating the next best serving assets for the geographic areas may include the management system 110 simulating scenarios where neighboring network assets take over service for geographic areas within the coverage band. The simulation may prioritize which assets should assume responsibility in the event of an outage or failure by evaluating the signal strength and quality of alternative assets. An example simulation may include projecting signal coverage from redundant assets in the vicinity of a failing asset.

Additionally, or alternatively, calculating the next best serving assets for the geographic areas may include the management system 110 performing a redundancy analysis to determine which assets provide the best overlap coverage in the case of a service disruption. This may include the management system 110 calculating an extent to which neighboring assets can compensate for a degrading or failing asset. For example, the redundancy analysis may utilize spatial data analytics to measure coverage overlap percentages and identify assets that could seamlessly assume service without significant signal quality loss. Redundancy may be visually mapped to highlight key overlap zones. Additionally, or alternatively, calculating the next best serving assets for the geographic areas may include the management system 110 evaluating the potential for service continuity across various geographic areas by alternative assets. The evaluation may consider factors such as signal strength, quality, and the ability to handle existing traffic loads. For example, the service continuity evaluation may rank alternative assets based on ability to maintain call quality and data throughput in high-density user areas.

Additionally, or alternatively, calculating the next best serving assets for the geographic areas may include the management system 110 compiling a catalog of replacement assets that can serve as alternatives for affected geographic areas within the coverage band. The catalog may be based on signal propagation models and real-time performance metrics. For example, the catalog may list specific assets with their corresponding performance metrics during past outage events, allowing for quick reference and action. Additionally, or alternatively, calculating the next best serving assets for the geographic areas may include the management system 110 devising a resource reallocation strategy to ensure seamless service in geographic areas experiencing asset failure. The management system 110 may dynamically adjust signal parameters and redirect traffic to neighboring assets in order to maintain network performance. For example, traffic originally handled by a failing asset may be rerouted to nearby assets with sufficient capacity and signal strength.

Additionally, or alternatively, calculating the next best serving assets for the geographic areas may include the management system 110 creating an optimal service map that highlights which network assets should take over service for specific geographic regions during outages. The map may be refined using real-time data analytics and historical usage patterns, thus allowing dynamic responses to service disruptions. Additionally, or alternatively, calculating the next best serving assets for the geographic areas may include the management system 110 processing asset plots to identify the next best assets for providing service in specific geographic areas. This may include the management system 110 analyzing the technical capabilities and historical reliability of various assets, such as their uptime records and maintenance schedules.

Additionally, or alternatively, calculating the next best serving assets for the geographic areas may include the management system 110 performing a geospatial analysis to determine a shift in coverage responsibilities among network assets under failure conditions. The analysis may consider the impact on the SNR and service reliability, ensuring that network performance standards are maintained despite asset failures. Additionally, or alternatively, calculating the next best serving assets for the geographic areas may include the management system 110 predicting which assets will be needed to provide backup service, enabling proactive reassignment before failures occur. The predictive approach may minimize service disruptions and may enhance network resilience by utilizing machine learning models to forecast potential failures and preemptively reallocate network resources.

As shown in FIG. 1E, and by reference number 145, the management system 110 may compute PDFs for the coverage band and the coverage tiers associated with next best serving assets. For example, the management system 110 may compute the PDFs to determine a statistical likelihood of coverage provided by the next best serving assets in the designated geographic areas. In some implementations, computing the PDFs may include the management system 110 generating PDFs for both the coverage band and the coverage tiers pertaining to potential backup assets. The management system 110 may calculate the PDFs to represent a likelihood of different signal strengths within the geographic areas, providing a detailed statistical picture of potential service disruptions and the efficacy of backup solutions. For example, the management system 110 may use historical signal strength data to generate these functions, ensuring that they accurately reflect real-world conditions.

Additionally, or alternatively, computing the PDFs may include the management system 110 determining the PDFs for the coverage band and the associated coverage tiers for assets that can take over the service. This may include analyzing metrics, such as RSRP and SINR, to understand the performance of backup assets in maintaining network coverage. Additionally, or alternatively, computing the PDFs may include the management system 110 utilizing statistical techniques, such as kernel density estimation, to form the PDFs for the coverage band and the coverage tiers related to next best serving assets. Kernel density estimation can provide a smooth, continuous estimation of probability density, offering a more nuanced understanding of coverage probabilities. For example, kernel density estimation may model the distribution of signal strengths under varying network loads and conditions.

Additionally, or alternatively, computing the PDFs may include the management system 110 identifying the likelihood of signal strength distributions for backup assets. This may include the management system 110 using empirical data to map out areas of potential signal degradation and identifying how well alternative assets can fill coverage gaps. Additionally, or alternatively, computing the PDFs may include the management system 110 computing PDFs for frequency bands and tiers that depict signal quality for regions served by the next best serving assets. This may include the management system 110 analyzing multiple frequency bands and geographic conditions to ensure that backup solutions are appropriately evaluated for all scenarios.

Additionally, or alternatively, computing the PDFs may include the management system 110 analyzing how well alternative assets can serve various regions. The analysis may aid in forming redundancy strategies for various geographic and environmental conditions. Additionally, or alternatively, computing the PDFs may include the management system 110 representing a statistical distribution of signal strengths across different geographic tiers, considering the next best serving assets. The statistical distribution may inform decisions on resource allocation and asset prioritization during potential outages. Additionally, or alternatively, computing the PDFs may include the management system 110 analyzing probabilities of different signal levels within the coverage band and geographic areas, focusing on the next best serving assets. The management system 110 may utilize the analysis to prepare for varying network demands and potential disruptions, ensuring consistent service quality.

As shown in FIG. 1F, and by reference number 150, the management system 110 may compute an intersection of the PDFs. For example, the management system 110 may compute the intersection of the PDFs to determine a statistical overlap between the coverage band for the primary network asset and the next best serving assets in the geographic areas. The intersection may be represented as a shared area under the curves of the PDFs, indicative of an extent to which the coverage areas of the asset and the backup assets overlap. In some implementations, the management system 110 may identify where the PDFs of the primary network asset and the next best serving assets intersect by calculating the share of coverage area under the curves of the PDFs. Determining these intersection points may provide an understanding of the geographical overlap and the degree of service continuity between the network assets.

Additionally, or alternatively, the management system 110 may calculate the intersection area of the PDFs by determining a statistical overlap and using numerical integration techniques to compute the precise shared area. For example, numerical methods, such as a trapezoidal rule or Simpson's rule, may be utilized to ensure the accuracy of the integration process. Additionally, or alternatively, the management system 110 may analyze the intersection of the PDFs to determine an overlap in coverage between the asset and alternative assets. The overlap in coverage may quantify redundancy by measuring the area under the intersecting curves. Moreover, analyzing the intersection may provide insights on optimizing the deployment of network assets to enhance overall network robustness.

As shown in FIG. 1G, and by reference number 155, the management system 110 may calculate an area under the intersection to generate a coverage overlap coefficient for the asset. For example, the management system 110 may calculate the area under the intersection of the PDFs by performing an integration calculation of the intersection. The management system 110 may utilize a result of the integration calculation to derive the coverage overlap coefficient, which quantifies an extent of coverage redundancy and overlap for the asset. The coverage overlap coefficient may be indicative of how much coverage can be maintained by the next best serving assets in the event of an outage of the asset, thus offering a measure for strategic network planning and maintenance decisions. The coverage overlap coefficient may aid in effective resource allocation and network optimization, network asset management, and optimization to maintain seamless service during outages.

As shown in FIG. 1H, and by reference number 160, the management system 110 may utilize the coverage overlap coefficient to scale KPIs of the asset and to generate updated KPIs of the asset. For example, the management system 110 may apply the coverage overlap coefficient to initial KPI values associated with the asset and may generate the updated KPIs based on applying the coverage overlap coefficient to the initial KPIs. The updated KPIs may reflect adjusted measurements of performance metrics, such as call drop rates, data throughput, or network latency, factoring in the coverage overlap coefficient. This adjustment provides a more accurate representation of network performance, especially in scenarios indicating potential network outages or transitions. In some implementations, the management system 110 may perform analyses of historical performance data and real-time network conditions when determining the updated KPIs for the asset. For example, where an original KPI might indicate a nominal performance metric, the updated KPI, modified by the coverage overlap coefficient, may show adjusted values accounting for potential coverage from backup assets, thereby informing a more strategic resource allocation or maintenance planning.

In some implementations, the management system 110 may use the coverage overlap coefficient to estimate the impact of an outage on service continuity by adjusting KPIs to reflect realistic coverage scenarios when the asset fails. For example, if a critical network site goes down, the coverage overlap coefficient may highlight how coverage redundancy mitigates service disruption, thereby providing actionable insights for outage management. Additionally, or alternatively, the management system 110 may utilize predictive analytics to forecast potential service disruptions. The coverage overlap coefficient may modify historical KPI trends to anticipate future performance impacts. For example, by analyzing past outage events and current network conditions, the management system 110 may dynamically adjust KPIs to predict the likelihood of service issues before they occur, facilitating proactive network management.

Additionally, or alternatively, the management system 110 may dynamically adjust KPIs in real-time by using the coverage overlap coefficient to reflect instantaneous changes in network conditions during an asset outage or service transition. Real-time adjustments can ensure that the KPIs provide the most current and accurate picture of network performance, allowing for immediate decisions to mitigate service impact. Additionally, or alternatively, the updated KPIs may provide insights that guide strategic decisions regarding network infrastructure, such as identifying priority sites for maintenance or upgrade based on coverage redundancy. These insights can drive higher-level planning and investment decisions, ensuring that network resources are allocated where they will have the most significant impact. Additionally, or alternatively, the updated KPIs may help diagnose underlying network issues, and improve understanding regarding whether performance drops are due to outages or overall infrastructure weaknesses. Additionally, or alternatively, the adjusted KPIs may be used in generating compliance reports that reflect more accurate service delivery metrics.

As shown in FIG. 1I, and by reference number 165, the management system 110 may perform one or more actions based on the updated KPIs. In some implementations, performing the one or more actions includes the management system 110 scheduling the asset for maintenance based on the updated KPIs. For example, the updated KPIs may indicate that a network site (e.g., an asset) requires maintenance to ensure consistent service quality. The management system 110 may generate a maintenance schedule that includes an entry to provide maintenance to the network site. In this way, the management system 110 conserves computing resources, networking resources, and/or other resources that would have otherwise been consumed by failing to provide a reliable, data-driven approach to quantify impacts of network asset outages.

In some implementations, performing the one or more actions includes the management system 110 generating a recommendation for the asset based on the updated KPIs. For example, the management system 110 may suggest optimal times for performing upgrades or replacements for the asset, may recommend taking preventive measures against potential failures of the asset, or may propose changes to operational parameters to mitigate risks to the asset highlighted by the updated KPIs. In this way, the management system 110 conserves computing resources, networking resources, and/or other resources that would have otherwise been consumed by generating suboptimal asset management and response strategies based on failing to accurately quantify impacts of network asset outages.

In some implementations, performing the one or more actions includes the management system 110 identifying missing neighbor relationships between the assets based on the updated KPIs. For example, the updated KPIs may reveal gaps in network coverage connectivity. The management system 110 may utilize this information to identify and establish new neighbor relationships (e.g., between the base stations 105) to improve handover efficiency and reduce dropped connections. This may include adding new base stations 105 to the network, modifying interrelations between the base stations 105, and/or the like. In this way, the management system 110 conserves computing resources, networking resources, and/or other resources that would have otherwise been consumed by failing to provide a reliable, data-driven approach to quantify impacts of network asset outages.

In some implementations, performing the one or more actions includes the management system 110 determining an anchoring impact on the assets based on the updated KPIs. “Anchoring impact” refers to understanding how a specific asset affects overall network stability and performance. The management system 110 may adjust network configurations accordingly, to minimize adverse anchoring impacts and stabilize network operations. In this way, the management system 110 conserves computing resources, networking resources, and/or other resources that would have otherwise been consumed by failing to provide a reliable, data-driven approach to quantify impacts of network asset outages.

In some implementations, performing the one or more actions includes the management system 110 identifying the assets with coverage overlap greater than a threshold based on the updated KPIs. For example, identifying the assets with coverage overlap greater than the threshold may enable the management system 110 to pinpoint areas where network resources are redundantly allocated, allowing for optimization and better utilization of network infrastructure by reallocating resources in a manner that enhances coverage efficiency and minimizes wastage. In this way, the management system 110 conserves computing resources, networking resources, and/or other resources that would have otherwise been consumed by generating suboptimal asset management and response strategies based on failing to accurately quantify impacts of network asset outages.

FIG. 1J is an example flow chart associated with the management system 110 estimating wireless network outage impact of a network asset. As shown at step 1 of FIG. 1J, the management system 110 may select assets for analysis. For example, the management system 110 may identify a list of network assets that require examination to estimate the impact of potential network outages. In some implementations, selecting assets for analysis may include the management system 110 identifying assets with the highest risk factors for outage.

As shown at step 2, the management system 110 may select a next asset from the selected assets. For example, the management system 110 may iterate through each asset in the list for detailed analysis. In some implementations, selecting the next asset may include the management system 110 cycling through prioritized assets sequentially. For example, each asset may be analyzed one after the other based on a pre-defined priority list.

As shown at step 3, the management system 110 may obtain a best server plot (BSP) RSRP for the asset. For example, the management system 110 may acquire BSP RSRP data for the particular asset being analyzed to understand its current service strength and coverage. In some implementations, obtaining BSP RSRP may include the management system 110 collecting historical RSRP data logged over a defined time period. This historical data can provide insights into the long-term performance of the asset.

As shown at step 4, for each of the assets, the management system 110 may identify distinct geobins where the BSP is located. For example, the BSP may cover geographic cells known as geobins, and the management system 110 may determine the exact locations of these geobins. In some implementations, identifying distinct geobins may include the management system 110 mapping geobins based on observational data from drive tests. For example, field engineers may collect data while driving through the coverage area, which is then used to map geobins.

As shown at step 5, the management system 110 may obtain all RSRPs for the geobins. For example, the management system 110 may collect signal strength data from all RSRPs present within the geobins where the BSP is identified. In some implementations, obtaining all RSRPs for geobins may include the management system 110 querying signal databases to obtain aggregated RSRP data.

As shown at step 6, the management system 110 may merge all of the RSRPs to the BSP and may drop the asset. For example, the management system 110 may compile all RSRP data and integrate the RSRP data with the BSP RSRP data, and may subsequently remove the original asset data for further assessment. In some implementations, merging RSRPs to BSP may include the management system 110 normalizing RSRP values and merging the normalized RSRP values with BSP data. Normalization may ensure that all data is on a comparable scale.

As shown at step 7, the management system 110 may compute an RSRP delta and sort by a strongest signal deltas. For example, the management system 110 may determine the difference in RSRP values for the asset under consideration and may sort the results to identify regions with the strongest signal deltas. This may enable the management system 110 to prioritize areas that experience the largest signal drop when the asset is removed, aiding in evaluating the impact of the asset's outage on overall network performance.

As shown at step 8, the management system 110 may compute a coverage band via grouping and keep with most geographic bins (geobins). For example, the management system 110 may segment the coverage area into smaller geographic bins (geobins) and may identify the coverage band that serves the maximum number of these geobins. This may ensure that the dominant frequency band providing extensive coverage is evaluated for its effectiveness and importance.

As shown at step 9, the management system 110 may group by geobin and keep a single strongest geobin. For example, the management system 110 may evaluate all the coverage bands within a geobin and may retain the strongest signal data for subsequent analysis. By doing so, the management system 110 may ensure that only the most reliable coverage indicators are used in determining the impact of a network asset outage.

As shown at step 10, the management system 110 may calculate coverage tiers from quartiles. For example, the management system 110 may analyze the distribution of signal strength values and employ quartile-based segmentation to classify the geographic areas into distinct coverage tiers (e.g., near-cell, mid-cell, and far-cell). This classification may aid in identifying areas with varying levels of service quality and informs further analysis steps.

As shown at step 11, the management system 110 may compute PDFs using kernel density estimation. For example, the management system 110 may utilize kernel density estimation to generate PDFs that represent the statistical distribution of signal strengths across the identified coverage bands and tiers. This may provide a probabilistic assessment of signal strength variations, and facilitates subsequent data integration steps.

As shown at step 12, the management system 110 may compute an intersection of the PDFs. For example, the management system 110 may determine the statistical overlap between the PDFs for the asset and the next best serving assets by calculating the shared area under the curve of the PDFs. This intersection represents the extent to which the service coverages of the asset and its alternatives overlap, providing a measure of network redundancy.

As shown at step 13, the management system 110 may calculate an area under the intersection, by performing integration, to derive a coverage overlap coefficient. For example, the management system 110 may perform an integration calculation of the intersection area of the PDFs to produce a coverage overlap coefficient that quantifies the level of redundancy in the network coverage. The coverage overlap coefficient may be utilized to modify calculated KPIs.

As shown at step 14, the management system 110 may join datasets of interest on a geobin. For example, the management system 110 may combine the computed coverage overlap data with other relevant datasets indexed by geobins, ensuring a holistic view of network performance and resource allocation.

As shown at step 15, the management system 110 may multiply KPIs of interest by the coverage overlap coefficient. For example, the management system 110 may adjust initial KPI values by scaling them with the coverage overlap coefficient to generate updated KPIs, reflecting a more accurate measure of network performance considering redundancy impacts.

As shown at step 16, the management system 110 may combine the KPIs, asset data, and statistics. For example, the management system 110 may compile the updated KPIs, relevant asset data, and other statistical information into a comprehensive dataset for analysis and decision-making purposes.

As shown at step 17, the management system 110 may determine whether more assets are to be analyzed. If more assets are to be analyzed (step 17—Yes), the management system 110 may repeat steps 2 through 16 for the remaining assets. If more assets are not to be analyzed (step 17—No), the management system 110 may proceed to step 18 and/or step 20.

As shown at step 18, the management system 110 may prioritize data based on asset metrics. For example, the management system 110 may rank assets by criticality using the compiled data, ensuring informed maintenance and optimization decisions.

As shown at step 19, the management system 110 may output recommendations. For example, the management system 110 may generate actionable insights and recommendations for network management, maintenance scheduling, and optimization based on the analysis results.

As shown at step 20, the management system 110 may obtain asset neighbor relation configurations. For example, the management system 110 may acquire configuration data about neighboring assets, facilitating the analysis of network interdependencies.

As shown at step 21, the management system 110 may format source and target assets. For example, the management system 110 may prepare the data for integration and analysis, ensuring accurate correspondence between source and target assets.

As shown at step 22, the management system 110 may join overlap asset information. For example, the management system 110 may compile overlap data between assets, providing insights into network redundancy and criticality. By combining this information, the management system 110 may ensure that no redundancies are overlooked.

As shown at step 23, the management system 110 may generate a list of overlap assets without neighbors for building missing relationships. For example, the management system 110 may identify network assets with significant overlap but lacking configured neighbor relationships, facilitating network optimization. The management system 110 may create a list of overlapping assets without established neighbor links for optimization. By creating such a list, the management system 110 may ensure targeted network relationship enhancements.

In this way, the management system 110 estimates a wireless network outage impact of a network asset. For example, the management system 110 may identify wireless network sites as assets, and may obtain geospatial coverage data for the network sites. The management system 110 may identify a coverage band for each network site, and may determine coverage tiers for the network sites. The management system 110 may calculate next best service alternatives, and may compute PDFs for overlapping coverage areas. The management system 110 may calculate an area under the PDFs to generate a coverage overlap coefficient, and may utilize the coverage overlap coefficient to adjust KPIs related to the network sites, which in turn informs maintenance schedules, replacement recommendations, or other optimization actions for the network sites. Thus, the management system 110 may conserve computing resources, networking resources, and/or other resources that would have otherwise been consumed by failing to provide a reliable, data-driven approach to quantifying impacts of network asset outages, generating suboptimal asset management and response strategies based on failing to accurately quantify impacts of network asset outages, especially in important scenarios, such as during natural disasters or high-demand events, and/or the like.

As indicated above, FIGS. 1A-1J are provided as an example. Other examples may differ from what is described with regard to FIGS. 1A-1J. The number and arrangement of devices shown in FIGS. 1A-1J are provided as an example. In practice, there may be additional devices, fewer devices, different devices, or differently arranged devices than those shown in FIGS. 1A-1J. Furthermore, two or more devices shown in FIGS. 1A-1J may be implemented within a single device, or a single device shown in FIGS. 1A-1J may be implemented as multiple, distributed devices. Additionally, or alternatively, a set of devices (e.g., one or more devices) shown in FIGS. 1A-1J may perform one or more functions described as being performed by another set of devices shown in FIGS. 1A-1J.

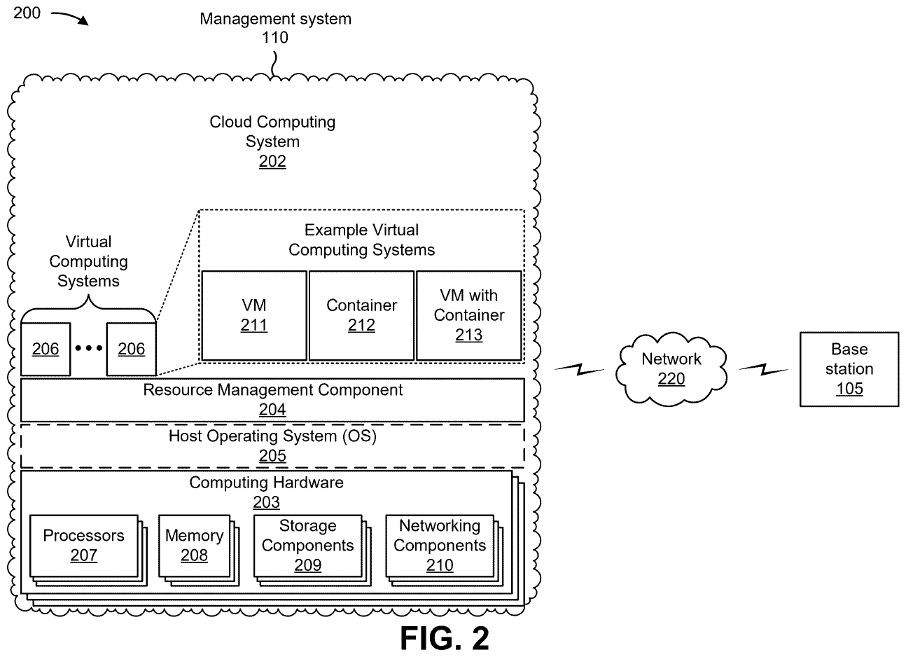

FIG. 2 is a diagram of an example environment 200 in which systems and/or methods described herein may be implemented. As shown in FIG. 2, the environment 200 may include the management system 110, which may include one or more elements of and/or may execute within a cloud computing system 202. The cloud computing system 202 may include one or more elements 203-213, as described in more detail below. As further shown in FIG. 2, the environment 200 may include the base station 105 and/or a network 220. Devices and/or elements of the environment 200 may interconnect via wired connections and/or wireless connections.

The base station 105 includes one or more devices capable of transferring traffic, such as audio, video, text, and/or other traffic, destined for and/or received from a user equipment (UE). For example, the base station 105 may include an eNodeB (eNB) associated with a long term evolution (LTE) network that receives traffic from and/or sends traffic to a core network, a gNodeB (gNB) associated with a radio access network (RAN) of a fifth-generation (5G) network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 105 may support, for example, a cellular radio access technology (RAT). The base station 105 may transfer traffic between a UE (e.g., using a cellular RAT), one or more other base stations 105 (e.g., using a wireless interface or a backhaul interface, such as a wired backhaul interface), and/or a core network. The base station 105 may provide one or more cells that cover geographic areas.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

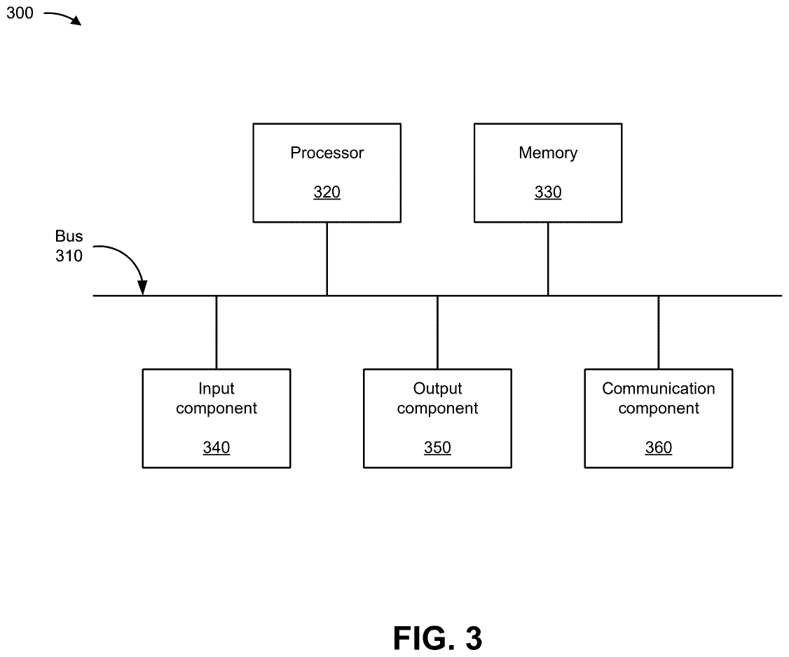

Although the management system 110 may include one or more elements 203-213 of the cloud computing system 202, may execute within the cloud computing system 202, and/or may be hosted within the cloud computing system 202, in some implementations, the management system 110 may not be cloud-based (e.g., may be implemented outside of a cloud computing system) or may be partially cloud-based. For example, the management system 110 may include one or more devices that are not part of the cloud computing system 202, such as the device 300 of FIG. 3, which may include a standalone server or another type of computing device. The management system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the base station 105 and/or the management system 110. In some implementations, the base station 105 and/or the management system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

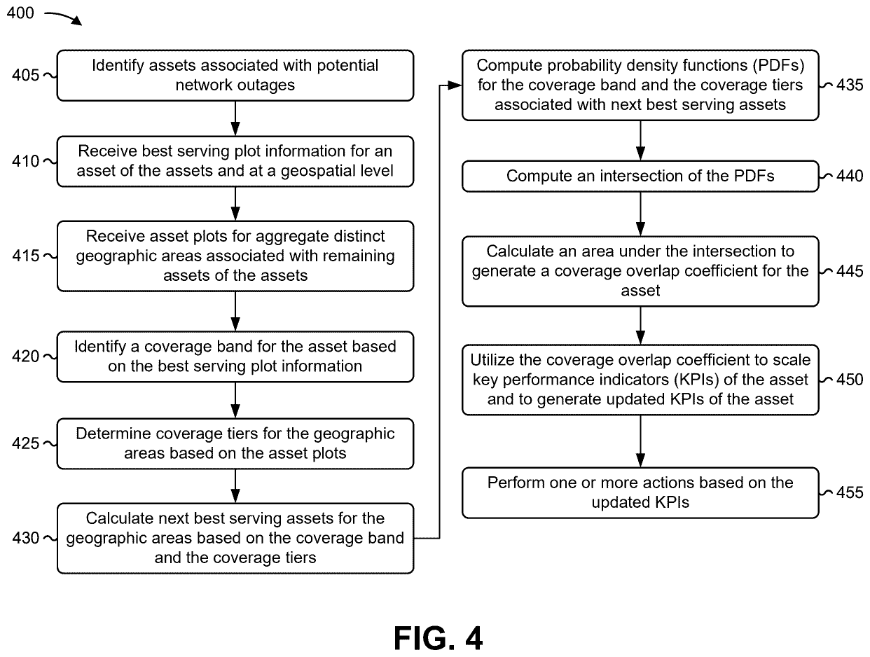

FIG. 4 is a flowchart of an example process 400 for estimating wireless network outage impact of a network asset. In some implementations, one or more process blocks of FIG. 4 may be performed by a device (e.g., the management system 110). In some implementations, one or more process blocks of FIG. 4 may be performed by another device or a group of devices separate from or including the device, such as a base station (e.g., the base station 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include identifying assets associated with potential network outages (block 405). For example, the device may identify assets associated with potential network outages, as described above. In some implementations, the assets include wireless network sites.

As further shown in FIG. 4, process 400 may include receiving best serving plot information for an asset of the assets and at a geospatial level (block 410). For example, the device may receive best serving plot information for an asset of the assets and at a geospatial level, as described above. In some implementations, the asset is a battery backup system of network equipment.

As further shown in FIG. 4, process 400 may include receiving asset plots for aggregate distinct geographic areas associated with remaining assets of the assets (block 415). For example, the device may receive asset plots for aggregate distinct geographic areas associated with remaining assets of the assets, as described above.

As further shown in FIG. 4, process 400 may include identifying a coverage band for the asset based on the best serving plot information (block 420). For example, the device may identify a coverage band for the asset based on the best serving plot information, as described above.

As further shown in FIG. 4, process 400 may include determining coverage tiers for the geographic areas based on the asset plots (block 425). For example, the device may determine coverage tiers for the geographic areas based on the asset plots, as described above.

As further shown in FIG. 4, process 400 may include calculating next best serving assets for the geographic areas based on the coverage band and the coverage tiers (block 430). For example, the device may calculate next best serving assets for the geographic areas based on the coverage band and the coverage tiers, as described above.

As further shown in FIG. 4, process 400 may include computing PDFs for the coverage band and the coverage tiers associated with next best serving assets (block 435). For example, the device may compute PDFs for the coverage band and the coverage tiers associated with next best serving assets, as described above.

As further shown in FIG. 4, process 400 may include computing an intersection of the PDFs (block 440). For example, the device may compute an intersection of the PDFs, as described above.

As further shown in FIG. 4, process 400 may include calculating an area under the intersection to generate a coverage overlap coefficient for the asset (block 445). For example, the device may calculate an area under the intersection to generate a coverage overlap coefficient for the asset, as described above.

As further shown in FIG. 4, process 400 may include utilizing the coverage overlap coefficient to scale KPIs of the asset and to generate updated KPIs of the asset (block 450). For example, the device may utilize the coverage overlap coefficient to scale KPIs of the asset and to generate updated KPIs of the asset, as described above. In some implementations, the updated KPIs of the asset provide an indication of an impact associated with an outage of the asset. In some implementations, the KPIs include metrics associated with one or more of call drop rates, data throughput, or network latency.

As further shown in FIG. 4, process 400 may include performing one or more actions based on the updated KPIs (block 455). For example, the device may perform one or more actions based on the updated KPIs, as described above. In some implementations, performing the one or more actions includes one or more of scheduling the asset for maintenance based on the updated KPIs, or generating a recommendation for the asset based on the updated KPIs. In some implementations, performing the one or more actions includes identifying missing neighbor relationships between the assets based on the updated KPIs. In some implementations, performing the one or more actions includes one or more of determining an anchoring impact on the assets based on the updated KPIs, or identifying the assets with coverage overlap greater than a threshold based on the updated KPIs.

In some implementations, performing the one or more actions includes recommending parameter adjustments for the asset or the remaining assets to minimize an outage impact associated with the asset. In some implementations, performing the one or more actions includes determining that a battery associated with the asset requires replacement based on the updated KPIs, and causing the battery to be replaced based on determining that the battery associated with the asset requires replacement.

In some implementations, process 400 includes calculating a criticality score for the asset based on the updated KPIs, and utilizing the criticality score to prioritize maintenance scheduling for the asset. In some implementations, process 400 includes identifying changing network conditions or outage events associated with the asset, and dynamically updating the coverage overlap coefficient and the updated KPIs in real-time based on the changing network conditions or the outage events.

In some implementations, process 400 includes comparing the coverage overlap coefficient across different bands and frequencies to account for spectrum-specific impacts on network performance. In some implementations, process 400 includes utilizing predictive analytics to forecast a potential outage impact of the asset, and adjusting prioritization of maintenance of the asset based on the potential outage impact of the asset. In some implementations, process 400 may include prioritizing replacement of the asset to ensure continuous operation of network equipment associated with the asset.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a device, assets associated with potential network outages;
receiving, by the device, best serving plot information for an asset of the assets and at a geospatial level;
receiving, by the device, asset plots for aggregate distinct geographic areas associated with remaining assets of the assets;
identifying, by the device, a coverage band for the asset based on the best serving plot information;
determining, by the device, coverage tiers for the geographic areas based on the asset plots;
calculating, by the device, next best serving assets for the geographic areas based on the coverage band and the coverage tiers;
computing, by the device, probability density functions (PDFs) for the coverage band and the coverage tiers associated with next best serving assets;
computing, by the device, an intersection of the PDFs;
calculating, by the device, an area under the intersection to generate a coverage overlap coefficient for the asset;
utilizing, by the device, the coverage overlap coefficient to scale key performance indicators (KPIs) of the asset and to generate updated KPIs of the asset; and
performing, by the device, one or more actions based on the updated KPIs.

2. The method of claim 1, wherein performing the one or more actions comprises one or more of:
scheduling the asset for maintenance based on the updated KPIs;
generating a recommendation for the asset based on the updated KPIs; or
identifying missing neighbor relationships between the assets based on the updated KPIs.

3. The method of claim 1, wherein performing the one or more actions comprises one or more of:
determining an anchoring impact on the assets based on the updated KPIs;
identifying the assets with coverage overlap greater than a threshold based on the updated KPIs; or
recommending parameter adjustments for the asset or the remaining assets to minimize an outage impact associated with the asset.

4. The method of claim 1, wherein the asset is a battery backup system of network equipment.

5. The method of claim 1, further comprising:
prioritizing replacement of the asset to ensure continuous operation of network equipment associated with the asset.

6. The method of claim 1, wherein the assets include wireless network sites.

7. The method of claim 1, wherein the updated KPIs of the asset provide an indication of an impact associated with an outage of the asset.

8. A device, comprising:
one or more processors configured to:
identify assets associated with potential network outages;
receive best serving plot information for an asset of the assets and at a geospatial level;
receive asset plots for aggregate distinct geographic areas associated with remaining assets of the assets;
identify a coverage band for the asset based on the best serving plot information;
determine coverage tiers for the geographic areas based on the asset plots;
calculate next best serving assets for the geographic areas based on the coverage band and the coverage tiers;
compute probability density functions (PDFs) for the coverage band and the coverage tiers associated with next best serving assets;
compute an intersection of the PDFs;
calculate an area under the intersection to generate a coverage overlap coefficient for the asset;
utilize the coverage overlap coefficient to scale key performance indicators (KPIs) of the asset and to generate updated KPIs of the asset,
wherein the updated KPIs of the asset provide an indication of an impact associated with an outage of the asset; and
perform one or more actions based on the updated KPIs.

9. The device of claim 8, wherein the one or more processors are further configured to:
calculate a criticality score for the asset based on the updated KPIs; and
utilize the criticality score to prioritize maintenance scheduling for the asset.

10. The device of claim 8, wherein the one or more processors are further configured to:
identify changing network conditions or outage events associated with the asset; and
dynamically update the coverage overlap coefficient and the updated KPIs in real-time based on the changing network conditions or the outage events.

11. The device of claim 8, wherein the KPIs include metrics associated with one or more of call drop rates, data throughput, or network latency.

12. The device of claim 8, wherein the one or more processors are further configured to:
compare the coverage overlap coefficient across different bands and frequencies to account for spectrum-specific impacts on network performance.

13. The device of claim 8, wherein the one or more processors are further configured to:
utilize predictive analytics to forecast a potential outage impact of the asset; and
adjust prioritization of maintenance of the asset based on the potential outage impact of the asset.

14. The device of claim 8, wherein the one or more processors, to perform the one or more actions, are configured to:
determine that a battery associated with the asset requires replacement based on the updated KPIs; and
cause the battery to be replaced based on determining that the battery associated with the asset requires replacement.

15. A non-transitory computer-readable medium storing a set of instructions, the set of instructions comprising:
one or more instructions that, when executed by one or more processors of a device, cause the device to:
identify assets associated with potential network outages;
receive best serving plot information for an asset of the assets and at a geospatial level;
receive asset plots for aggregate distinct geographic areas associated with remaining assets of the assets;
identify a coverage band for the asset based on the best serving plot information;
determine coverage tiers for the geographic areas based on the asset plots;
calculate next best serving assets for the geographic areas based on the coverage band and the coverage tiers;
compute probability density functions (PDFs) for the coverage band and the coverage tiers associated with next best serving assets;
compute an intersection of the PDFs;
calculate an area under the intersection to generate a coverage overlap coefficient for the asset;
utilize the coverage overlap coefficient to scale key performance indicators (KPIs) of the asset and to generate updated KPIs of the asset,
wherein the KPIs include metrics associated with one or more of call drop rates, data throughput, or network latency; and
perform one or more actions based on the updated KPIs.

16. The non-transitory computer-readable medium of claim 15, wherein the one or more instructions, that cause the device to perform the one or more actions, cause the device to one or more of:
schedule the asset for maintenance based on the updated KPIs;
generate a recommendation for the asset based on the updated KPIs.
identify missing neighbor relationships between the assets based on the updated KPIs;
determine an anchoring impact on the assets based on the updated KPIs;
identify the assets with coverage overlap greater than a threshold based on the updated KPIs; or
recommend parameter adjustments for the asset or the remaining assets to minimize an outage impact associated with the asset.

17. The non-transitory computer-readable medium of claim 15, wherein the one or more instructions further cause the device to:
calculate a criticality score for the asset based on the updated KPIs; and
utilize the criticality score to prioritize maintenance scheduling for the asset.

18. The non-transitory computer-readable medium of claim 15, wherein the one or more instructions further cause the device to:
identify changing network conditions or outage events associated with the asset; and
dynamically update the coverage overlap coefficient and the updated KPIs in real-time based on the changing network conditions or the outage events.

19. The non-transitory computer-readable medium of claim 15, wherein the one or more instructions further cause the device to:
compare the coverage overlap coefficient across different bands and frequencies to account for spectrum-specific impacts on network performance.

20. The non-transitory computer-readable medium of claim 15, wherein the one or more instructions further cause the device to:
utilize predictive analytics to forecast a potential outage impact of the asset; and
adjust prioritization of maintenance of the asset based on the potential outage impact of the asset.
